(19) United States
(12) Patent Application Publication
(10) Pub. No.: US 2025/0285788 A1
(43) Pub. Date: Sep. 11, 2025

(54) CABLE WITH IMPROVED SHIELDING EFFECT

(71) Applicant: DONGGUAN LUXSHARE TECHNOLOGIES CO., LTD, Dongguan City (CN)

(72) Inventors: Zhongchao PENG, Dongguan City (CN); Jinchang DAI, Dongguan City (CN); Bentao HU, Dongguan City (CN); Huanzhong YAN, Dongguan City (CN); Charles Lloyd GRANT, Dongguan City (CN); Andrew John NOWAK, Dongguan City (CN)

(73) Assignee: DONGGUAN LUXSHARE TECHNOLOGIES CO., LTD, Dongguan City (CN)

(21) Appl. No.: 19/220,536

(22) Filed: May 28, 2025

Related U.S. Application Data
(63) Continuation of application No. 18/224,357, filed on Jul. 20, 2023.

(30) Foreign Application Priority Data
Aug. 30, 2022 (CN) 202211043805.5

(51) Int. Cl. H01B 11/06; H01B 7/02; H01B 11/00; H01B 13/06

(52) U.S. Cl. CPC H01B 11/06; H01B 7/0208; H01B 11/002; H01B 13/06

(57) ABSTRACT

A cable includes a core wire, a shielding layer located on a periphery of the core wire, and an insulating skin at least partially located on a periphery of the shielding layer. The shielding layer includes at least a first metal layer and a second metal layer. The first metal layer and the second metal layer have different metal materials. The first metal layer and the second metal layer are integrally composited. With this arrangement, the shielding effect of the cable is improved.

### CROSS-REFERENCE TO RELATED APPLICATIONS

This application is a continuation of U.S. patent application Ser. No. 18/224,357, filed on Jul. 20, 2023, which claims priority of a Chinese Patent Application No. 202211043805.5, filed on Aug. 30, 2022 and titled “CABLE”, the entire content of which is incorporated herein by reference.

### TECHNICAL FIELD

The present disclosure relates to a cable, which belongs to the technical field of cable connectors.

### BACKGROUND

With the development and popularization of electronic technology products, signal cables are widely used in home appliances, instrumentation, automation equipment, data centers, servers, switches, cloud computing and 5G fields as a signal transmission tool. However, in the process of signal transmission, cables are easily interfered by external electromagnetic signals, so shielding structure design is often required to eliminate or reduce the interference of external electromagnetic fields, and at the same time, it can prevent the leakage of transmission signals.

Therefore, it is desirable to provide a cable with improved shielding effect and stable signal transmission to solve the above problems.

### SUMMARY

The present disclosure adopts the following technical solution: a cable, including: a core wire; a shielding layer located on a periphery of the core wire around a circumference direction; the shielding layer including at least a first metal layer and a second metal layer; the first metal layer and the second metal layer having different metal materials; the first metal layer and the second metal layer being integrally composited; and an insulating skin, at least part of the insulating skin being located on a periphery of the shielding layer around the circumference direction; wherein the shielding layer includes a first joint portion, a second joint portion and an overlapping area; the overlapping area is formed by superimposing the first joint portion of the shielding layer and the second joint portion of the shielding layer; the first metal layer of the first joint portion and the second metal layer of the second joint portion are in contact with each other at the overlapping area; wherein the shielding layer includes a first arc-shaped portion, a second arc-shaped portion opposite to the first arc-shaped portion, a first straight portion connecting one side of the first arc-shaped portion and one side of the second arc-shaped portion, and a connecting area opposite to the first straight portion; the connecting area includes the overlapping area and a second straight portion; the first joint portion is connected to the first arc-shaped portion; the second straight portion is connected to the second arc portion; wherein the connecting area further includes a raised portion; opposite sides of the raised portion are connected to the second joint portion and the second straight portion, respectively; and the raised portion gradually moves away from the core wire from the second straight portion toward the second joint portion; the cable is not provided with any ground wire, and at least part of the first metal layer of the second joint portion protruded in a direction away from the core wire through the raised portion is configured to be exposed from the insulating skin to contact an external grounding portion outside the cable.

The present disclosure also adopts the following technical solution: a cable, including: a core wire including: a first metal conductor; a first insulator at least partially wrapped around the first metal conductor along a circumference direction; a second metal conductor, the first metal conductor and the second metal conductor being disposed side by side along a width direction; and a second insulator at least partially wrapped around the second metal conductor along the circumference direction; a shielding layer located on a periphery of the first insulator and a periphery of the second insulator around the circumference direction; the shielding layer including at least a first metal layer and a second metal layer; the first metal layer and the second metal layer having different metal materials; the first metal layer and the second metal layer being integrally composited directly; and an insulating skin, at least part of the insulating skin being located on a periphery of the shielding layer around the circumference direction; wherein the first metal layer is an outer layer of the shielding layer away from the core wire; the second metal layer is an inner layer of the shielding layer close to the core wire; wherein the shielding layer includes a first joint portion, a second joint portion and an overlapping area; the overlapping area is formed by superimposing the first joint portion of the shielding layer and the second joint portion of the shielding layer; the first metal layer of the first joint portion and the second metal layer of the second joint portion are in contact with each other at the overlapping area; wherein the shielding layer includes a first arc-shaped portion, a second arc-shaped portion opposite to the first arc-shaped portion, a first straight portion connecting one side of the first arc-shaped portion and one side of the second arc-shaped portion, and a connecting area opposite to the first straight portion; the connecting area includes the overlapping area and a second straight portion; the first joint portion is connected to the first arc-shaped portion; the second straight portion is connected to the second arc portion; wherein the connecting area further includes a raised portion; opposite sides of the raised portion are connected to the second joint portion and the second straight portion, respectively; and the raised portion gradually moves away from the core wire from the second straight portion toward the second joint portion; the cable is not provided with any ground wire, and at least part of the first metal layer of the second joint portion serves as a grounding element of the cable; and wherein the first metal conductor, the first insulator, the second metal conductor, the second insulator and the shielding layer are exposed outside the insulating skin; the first metal conductor extends beyond the first insulator along an axial direction; the second metal conductor extends beyond the second insulator along the axial direction; the first insulator and the second insulator extend beyond the shielding layer along the axial direction; and the shielding layer extends beyond the insulating skin along the axial direction.

The present disclosure further adopts the following technical solution: a cable, including: a first metal conductor; a first insulator at least partially wrapped around the first metal conductor along a circumference direction; a second metal conductor, the first metal conductor and the second metal conductor being disposed side by side along a width direction; a second insulator at least partially wrapped around the second metal conductor along the circumference direction; an intermediate layer material wrapped around the first insulator and the second insulator along the circumference direction; a shielding layer wrapped around the intermediate layer around the circumference direction; the shielding layer including at least a first metal layer and a second metal layer; the first metal layer and the second metal layer having different metal materials; the first metal layer and the second metal layer being integrally composited directly; an insulating layer located on a periphery of the shielding layer; and an insulating skin wrapped around the insulating layer and the shielding layer around the circumference direction; wherein the first metal layer is an outer layer of the shielding layer, and the second metal layer is an inner layer of the shielding layer; wherein the shielding layer includes a first joint portion, a second joint portion and an overlapping area; the overlapping area is formed by superimposing the first joint portion of the shielding layer and the second joint portion of the shielding layer; the first metal layer of the first joint portion and the second metal layer of the second joint portion are in contact with each other at the overlapping area; wherein the shielding layer includes a first arc-shaped portion, a second arc-shaped portion opposite to the first arc-shaped portion, a first straight portion connecting one side of the first arc-shaped portion and one side of the second arc-shaped portion, and a connecting area opposite to the first straight portion; the connecting area includes the overlapping area and a second straight portion; the first joint portion is connected to the first arc-shaped portion; the second straight portion is connected to the second arc portion; wherein the connecting area further includes a raised portion; opposite sides of the raised portion are connected to the second joint portion and the second straight portion, respectively; and the raised portion gradually moves away from the second straight portion toward the second joint portion; the cable is not provided with any ground wire, and at least part of the first metal layer of the second joint portion serves as a grounding element of the cable; wherein the first metal layer of the first joint portion and the second metal layer of the second joint portion are in direct contact with each other at the overlapping area; the second metal layer of the first joint portion is integrally composited to an inner side of the first metal layer of the first joint portion; and the first metal layer of the second joint portion is integrally composited to an outer side of the second metal layer of the second joint portion; and wherein the first metal conductor, the first insulator, the second metal conductor, the second insulator, the intermediate layer material, the shielding layer and the insulating layer are exposed outside the insulating skin.

### BRIEF DESCRIPTION OF DRAWINGS

FIG. 1 is a front view of a cable in accordance with an embodiment of the present disclosure;

FIG. 2 is a bottom view of FIG. 1;

FIG. 3 is a top view of FIG. 1;

FIG. 4 is a schematic structural view of a shielding layer in FIG. 1;

FIG. 5 is a schematic cross-sectional structural view of the shielding layer in accordance with an embodiment of the present disclosure;

FIG. 6 is a schematic cross-sectional structural view of the shielding layer in accordance with another embodiment of the present disclosure;

FIG. 7 is a schematic cross-sectional structure view of area A in FIG. 4 according to an embodiment of the present disclosure; and

FIG. 8 is a schematic cross-sectional structure view of area A in FIG. 4 according to another embodiment of the present disclosure.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

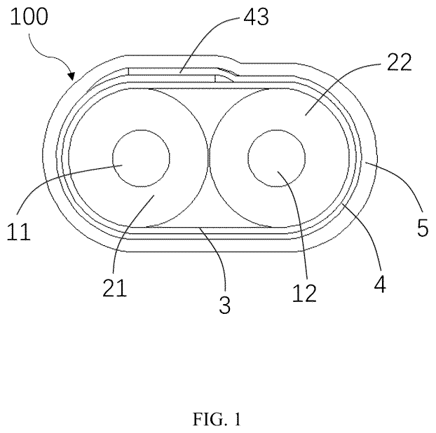

Referring to FIG. 1, the present embodiment discloses a cable 100 including a core wire, an intermediate layer material 3 at least partially located on a periphery of the core wire, a shielding layer 4 at least partially located on a periphery of the intermediate layer material 3, and an insulating skin 5 at least partially located on a periphery of the shielding layer 4.

In an embodiment of the present disclosure, the core wire includes a first metal conductor 11, a first insulator 21 at least partially wrapped on the first metal conductor 11, a second metal conductor 12, and a second insulator 22 at least partially wrapped on the second metal conductor 12. The intermediate layer material 3 is at least partially wrapped on the first insulator 21 and the second insulator 22. Of course, in another embodiment, the first insulator 21 and the second insulator 22 can also be formed as an integral insulator 2, for example, in an oval shape.

In the embodiment shown in the present disclosure, the first metal conductor 11 and the second metal conductor 12 are both cylindrical. The first metal conductor 11 is used for transmitting a first signal, and the second metal conductor 12 is used for transmitting a second signal. In an embodiment of the present disclosure, the first signal and the second signal form a high-speed differential pair. In an embodiment of the present disclosure, the first metal conductor 11 and the second metal conductor 12 are both silver-plated copper wires so as to improve the quality of signal transmission.

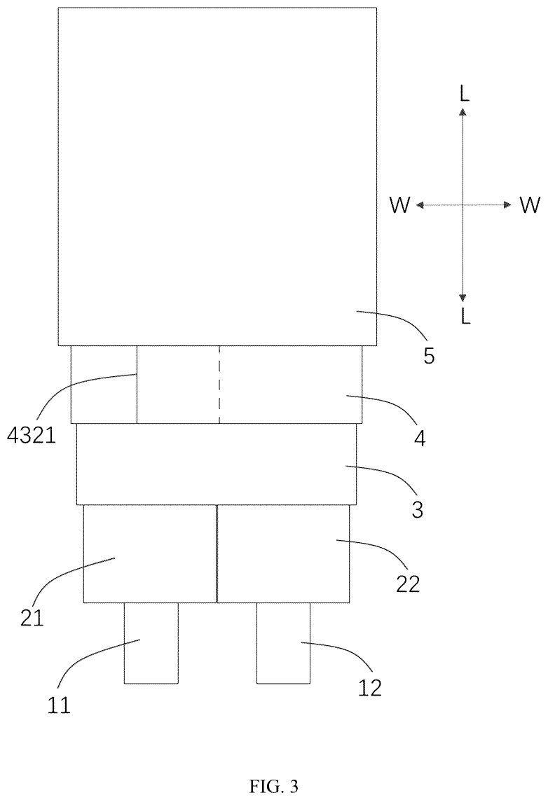

Referring to FIG. 1 to FIG. 3, in an embodiment of the present disclosure, the first insulator 21 and the second insulator 22 both extend along a longitudinal direction L-L. The first insulator 21 and the second insulator 22 are adjacent to, parallel to, and in contact with each other. The first insulator 21 and the second insulator 22 are arranged side by side along a width direction W-W perpendicular to the longitudinal direction L-L. The first insulator 21 and the second insulator 22 are both cylindrical.

In an embodiment of the present disclosure, the first insulator 21 is a polyolefin or a fluoropolymer, and the second insulator 21 is a polyolefin or a fluoropolymer. The materials of the first insulator 21 and the second insulator 21 may be the same or different. The intermediate layer material 3 is a buffer insulating layer wound or sleeved outside the first insulator 21 and the second insulator 21. The intermediate layer material 3 has functions of insulation and buffering.

In an embodiment of the present disclosure, the intermediate layer material 3 is made of foamed polyolefin, such as foamed polypropylene. The intermediate layer material 3 is spirally wound on the first insulator 21 and the second insulator 22 along the longitudinal direction L-L of the cable 100. Specifically, the intermediate layer material 3 is continuously wound on the first insulator 21 and the second insulator 22 along the longitudinal direction L-L of the cable 100. Of course, in other embodiments, the intermediate layer material 3 may also be directly sleeved on the first insulator 21 and the second insulator 22.

The shielding layer 4 at least includes a first metal layer 421 and a second metal layer 422. The first metal layer 421 and the second metal layer 422 have different metal materials, respectively. The first metal layer 421 and the second metal layer 422 are integrally composited. The first metal layer 421 is an outer layer of the shielding layer 4 away from the core wire, and the second metal layer 422 is an inner layer of the shielding layer 4 close to the core wire. The cable is not provided with a ground wire. Instead, at least a portion of the first metal layer 421 is configured as a ground element of the cable.

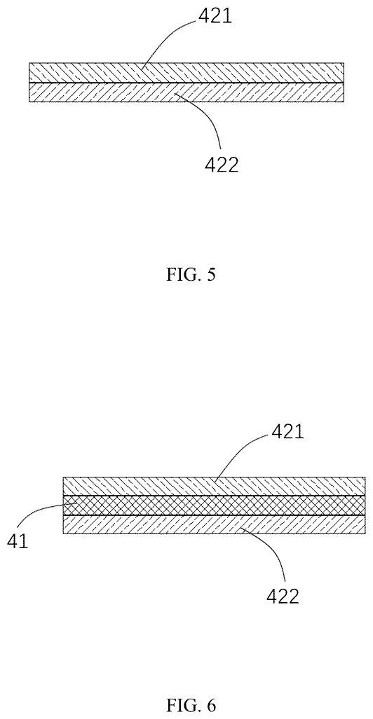

Referring to an embodiment shown in FIG. 5, the shielding layer 4 includes a first metal layer 421 and a second metal layer 422. The first metal layer 421 and the second metal layer 422 are directly integrated with each other through high temperature and high pressure. For example, the shielding layer 4 may be an integrated high temperature and high pressure composite layer. Referring to another embodiment shown in FIG. 6, the shielding layer 4 includes a base film 41, a first metal layer 421 and a second metal layer 422 which are compounded on two sides of the base film 41, respectively. The first metal layer 421 and the second metal layer 422 are integrated with the two sides of the base film 41, respectively, through an adhesive. For example, the shielding layer 4 may be an adhesive composite layer.

The base film 41 can be made of polyester material, such as polyethylene terephthalate. The first metal layer 421 is an outer layer of the shielding layer 4 away from the core wire, and the second metal layer 422 is an inner layer of the shielding layer 4 close to the core wire. The first metal layer 421 includes a copper foil, and the second metal layer 422 includes an aluminum foil.

The copper foil is formed as the outer layer of the shielding layer 4, and the aluminum foil is formed as the inner layer of the shielding layer 4. This is because the copper foil is easy to be soldered or welded to a grounding portion of the connector, and a surface of the aluminum foil is easily oxidized. An oxide layer is firm and refractory, making soldering/welding difficult, but the aluminum foil has good toughness, so that the shielding layer 4 is not easy to break.

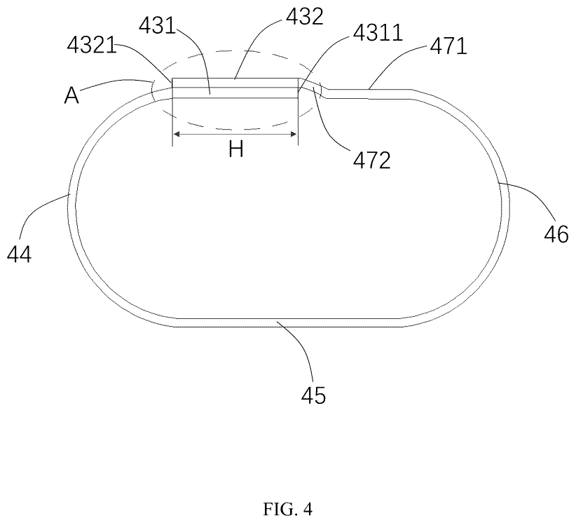

Referring to FIG. 1 and FIG. 4, the shielding layer 4 includes two joint portions and an overlapping area 43. The overlapping area 43 is formed by superimposing the two joint portions of the shielding layer 4. The copper foil of one joint portion and the aluminum foil of the other joint portion are in contact with each other, so as to improve electrical performance. In an embodiment of the present disclosure, one of the joint portions is the first joint portion 431, and the other of the joint portions is the second joint portion 432. The second joint portion 432 is superimposed on the first joint portion 431. The copper foil of the first joint portion 431 and the aluminum foil of the second joint portion 432 are in contact with each other to achieve contact conduction.

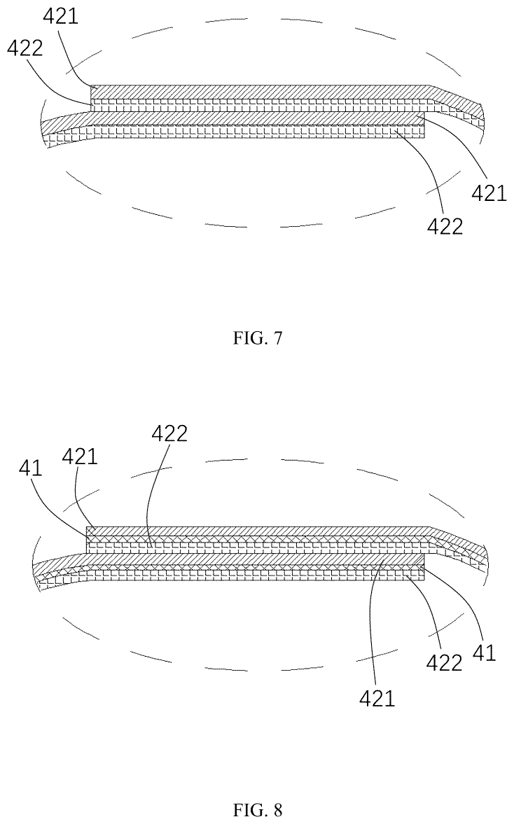

Specifically, referring to FIG. 7 and FIG. 8, the first joint portion 431 is close to the core wire relative to the second joint portion 432, and the first metal layer 421 of the first joint portion 432 is close to the core wire relative to the second metal layer 422 of the second joint portion 432. The first metal layer 421 of the first joint portion 431 and the second metal layer 422 of the second joint portion 432 are in contact with each other.

In an embodiment of the present disclosure, referring to FIG. 1 and FIG. 4, a distance between a central axis of the first metal conductor 11 and a central axis of the second metal conductor 12 is S. The first joint portion 431 has a first end surface 4311, the second joint portion 432 has a second end surface 4321, and a distance between the first end surface 4311 and the second end surface 4321 along the width direction W-W is H; where S>H.

In an embodiment of the present disclosure, as shown in FIG. 4, the shielding layer 4 includes a first arc-shaped portion 44, a second arc-shaped portion 46 opposite to the first arc-shaped portion 44, a first straight portion 45 connecting one side of the first arc-shaped portion 44 and one side of the second arc-shaped portion 46, and a connecting area opposite to the first straight portion 45. The connecting area includes the overlapping area 43 and a second straight portion 471. The first joint portion 431 may be connected to the first arc-shaped portion 44 or may be connected to the second straight portion 471. Opposite sides of the second straight portion 471 are connected to the second arc portion 46 and the second joint portion 432, respectively.

Further, the connecting area further includes a raised portion 472. Opposite sides of the raised portion 472 are connected to the second joint portion 432 and the second straight portion 471, respectively. The raised portion 472 gradually moves away from the core wire from the second straight portion 471 toward the second connector 432. In some embodiments, the second joint portion 432 is protruded in a direction away from the core wire through the raised portion 472, so that the first metal layer 421 on the outer side of the second joint portion 432 can be more easily soldered or welded to the grounding portion of the connector, or more easily to contact the grounding portion of the connector to improve the electrical effect. As previously mentioned, the insulating skin 5 is at least partially located on the periphery of the shielding layer 4, the shielding layer 4 may be partially exposed from the insulating skin 5 to allow the first metal layer 421 on the outer side of the second joint portion 432 having capability to contact the grounding portion of the connector.

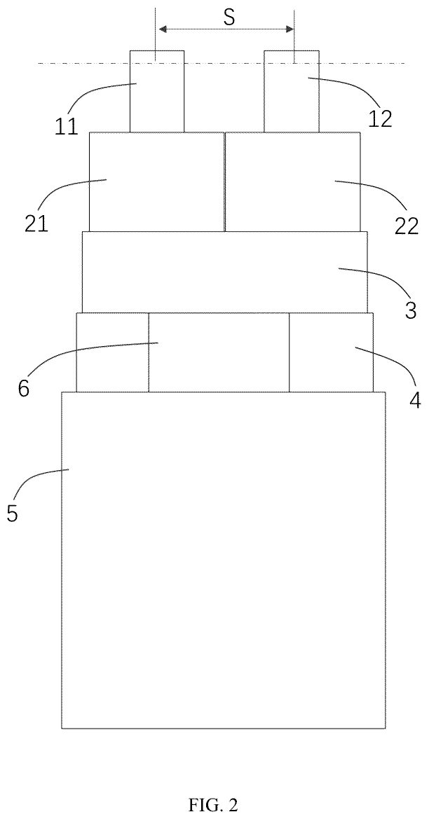

In an embodiment of the present disclosure, as shown in FIG. 2, the cable 100 further includes an insulating layer 6 at least partially wrapped on or attached to the shielding layer 4. The insulating layer 6 is disposed between the shielding layer 4 and the insulating skin 5. Specifically, the insulating layer 6 is attached to part of the first straight portion 45. By arranging the insulating layer 6, the tight coupling of the cable 100 is increased, so as to achieve the purpose of reducing attenuation. The insulating layer 6 is polyolefin or fluoropolymer.

In an embodiment of the present disclosure, the insulating skin 5 may be made of polyester material.

The present disclosure not only increases a thickness of the shielding layer 4 but also improves the shielding effect of the cable and improves the reliability of signal transmission by providing the double-layer metal layers. The first metal layer 421 is an outer layer of the shielding layer 4. The outer layer is made of copper foil, and the copper foil can be directly soldered or welded to the grounding portion of the connector to form a shielding surface to isolate the signal interference at the joint. At the same time, the setting of the ground wire is cancelled, and the volume of the cable 100 is reduced. The second metal layer 422 is made of aluminum foil, and the first metal layer 421 is made of copper foil, so that the shielding layer 4 has better shielding effect, enhanced toughness, and is not easy to break.

The above embodiments are only used to illustrate the present disclosure and not to limit the technical solutions described in the present disclosure. The understanding of this specification should be based on those skilled in the art. Descriptions of directions, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A cable, comprising:
a core wire;
a shielding layer located on a periphery of the core wire around a circumference direction;
the shielding layer comprising at least a first metal layer and a second metal layer; the first metal layer and the second metal layer having different metal materials; the first metal layer and the second metal layer being integrally composited; and
an insulating skin, at least part of the insulating skin being located on a periphery of the shielding layer around the circumference direction;
wherein the shielding layer comprises a first joint portion, a second joint portion and an overlapping area; the overlapping area is formed by superimposing the first joint portion of the shielding layer and the second joint portion of the shielding layer; the first metal layer of the first joint portion and the second metal layer of the second joint portion are in contact with each other at the overlapping area;
wherein the shielding layer comprises a first arc-shaped portion, a second arc-shaped portion opposite to the first arc-shaped portion, a first straight portion connecting one side of the first arc-shaped portion and one side of the second arc-shaped portion, and a connecting area opposite to the first straight portion; the connecting area comprises the overlapping area and a second straight portion; the first joint portion is connected to the first arc-shaped portion; the second straight portion is connected to the second arc portion; and
wherein the connecting area further comprises a raised portion; opposite sides of the raised portion are connected to the second joint portion and the second straight portion, respectively; and the raised portion gradually moves away from the core wire from the second straight portion toward the second joint portion; the cable is not provided with any ground wire, and at least part of the first metal layer of the second joint portion protruded in a direction away from the core wire through the raised portion is configured to be exposed from the insulating skin to contact an external grounding portion outside the cable.

2. The cable according to claim 1, wherein the shielding layer is a high temperature and high pressure composite layer in which the first metal layer and the second metal layer are directly integrated with each other without any non-metal layer disposed between the first metal layer and the second metal layer.

3. The cable according to claim 2, wherein the first metal layer of the first joint portion and the second metal layer of the second joint portion are in direct contact with each other at the overlapping area; the second metal layer of the first joint portion is integrally composited to an inner side of the first metal layer of the first joint portion; and the first metal layer of the second joint portion is integrally composited to an outer side of the second metal layer of the second joint portion.

4. The cable according to claim 1, wherein the shielding layer comprises a base film; the first metal layer and the second metal layer are integrally composited on two sides of the base film, respectively.

5. The cable according to claim 1, wherein the first metal layer is an outer layer of the shielding layer away from the core wire; the second metal layer is an inner layer of the shielding layer close to the core wire.

6. The cable according to claim 1, wherein the first metal layer is an outer layer of the shielding layer away from the core wire; the second metal layer is an inner layer of the shielding layer close to the core wire; the first metal layer comprises a copper foil; and the second metal layer comprises an aluminum foil.

7. The cable according to claim 6, wherein the copper foil of the first joint portion and the aluminum foil of the second joint portion are in contact with each other at the overlapping area.

8. The cable according to claim 7, wherein the first joint portion is close to the core wire relative to the second joint portion; the first metal layer of the first joint portion is close to the core wire relative to the second metal layer of the second joint portion.

9. The cable according to claim 7, wherein the core wire comprises a first metal conductor, a first insulator at least partially wrapped around the first metal conductor along the circumference direction, a second metal conductor, and a second insulator at least partially wrapped around the second metal conductor along the circumference direction.

10. The cable according to claim 9, wherein a distance between a central axis of the first metal conductor and a central axis of the second metal conductor is S; and
wherein the first joint portion has a first end face, the second joint portion has a second end face, and a distance between the first end surface and the second end surface along a width direction is H; where S>H.

11. The cable according to claim 1, wherein the at least part of the first metal layer of the second joint portion of the raised portion is configured to be soldered or welded to a grounding portion of a connector.

12. A cable, comprising:
a core wire comprising:
a first metal conductor;
a first insulator at least partially wrapped around the first metal conductor along a circumference direction;
a second metal conductor, the first metal conductor and the second metal conductor being disposed side by side along a width direction; and
a second insulator at least partially wrapped around the second metal conductor along the circumference direction;
a shielding layer located on a periphery of the first insulator and a periphery of the second insulator around the circumference direction; the shielding layer comprising at least a first metal layer and a second metal layer; the first metal layer and the second metal layer having different metal materials; the first metal layer and the second metal layer being integrally composited directly; and
an insulating skin, at least part of the insulating skin being located on a periphery of the shielding layer around the circumference direction;
wherein the first metal layer is an outer layer of the shielding layer away from the core wire;
the second metal layer is an inner layer of the shielding layer close to the core wire;
wherein the shielding layer comprises a first joint portion, a second joint portion and an overlapping area; the overlapping area is formed by superimposing the first joint portion of the shielding layer and the second joint portion of the shielding layer; the first metal layer of the first joint portion and the second metal layer of the second joint portion are in contact with each other at the overlapping area;
wherein the shielding layer comprises a first arc-shaped portion, a second arc-shaped portion opposite to the first arc-shaped portion, a first straight portion connecting one side of the first arc-shaped portion and one side of the second arc-shaped portion, and a connecting area opposite to the first straight portion; the connecting area comprises the overlapping area and a second straight portion; the first joint portion is connected to the first arc-shaped portion; the second straight portion is connected to the second arc portion;
wherein the connecting area further comprises a raised portion; opposite sides of the raised portion are connected to the second joint portion and the second straight portion, respectively; and the raised portion gradually moves away from the core wire from the second straight portion toward the second joint portion; the cable is not provided with any ground wire, and at least part of the first metal layer of the second joint portion serves as a grounding element of the cable; and
wherein the first metal conductor, the first insulator, the second metal conductor, the second insulator and the shielding layer are exposed outside the insulating skin; the first metal conductor extends beyond the first insulator along an axial direction; the second metal conductor extends beyond the second insulator along the axial direction; the first insulator and the second insulator extend beyond the shielding layer along the axial direction; and the shielding layer extends beyond the insulating skin along the axial direction.

13. The cable according to claim 12, wherein the shielding layer is a high temperature and high pressure composite layer in which the first metal layer and the second metal layer are directly integrated with each other without any non-metal layer disposed between the first metal layer and the second metal layer.

14. The cable according to claim 12, wherein the first metal layer of the first joint portion and the second metal layer of the second joint portion are in direct contact with each other at the overlapping area; the second metal layer of the first joint portion is integrally composited to an inner side of the first metal layer of the first joint portion; and the first metal layer of the second joint portion is integrally composited to an outer side of the second metal layer of the second joint portion.

15. The cable according to claim 12, wherein the shielding layer comprises a base film; the first metal layer and the second metal layer are integrally composited on two sides of the base film, respectively.

16. The cable according to claim 12, further comprising an intermediate layer material; wherein the intermediate layer material is wrapped around the first insulator and the second insulator along the circumference direction; and the shielding layer is wrapped around the intermediate layer material along the circumference direction.

17. The cable according to claim 12, wherein the first metal layer comprises a copper foil, and the second metal layer comprises an aluminum foil.

18. The cable according to claim 17, wherein the copper foil of the first joint portion and the aluminum foil of the second joint portion are in contact with each other at the overlapping area.

19. The cable according to claim 18, wherein a distance between a central axis of the first metal conductor and a central axis of the second metal conductor is S; and
wherein the first joint portion has a first end face, the second joint portion has a second end face, and a distance between the first end surface and the second end surface along the width direction is H; where S>H.

20. A cable, comprising:
a first metal conductor;
a first insulator at least partially wrapped around the first metal conductor along a circumference direction;
a second metal conductor, the first metal conductor and the second metal conductor being disposed side by side along a width direction;
a second insulator at least partially wrapped around the second metal conductor along the circumference direction;
an intermediate layer material wrapped around the first insulator and the second insulator along the circumference direction;
a shielding layer wrapped around the intermediate layer around the circumference direction;
the shielding layer comprising at least a first metal layer and a second metal layer; the first metal layer and the second metal layer having different metal materials; the first metal layer and the second metal layer being integrally composited directly;
an insulating layer located on a periphery of the shielding layer; and
an insulating skin wrapped around the insulating layer and the shielding layer around the circumference direction;
wherein the first metal layer is an outer layer of the shielding layer, and the second metal layer is an inner layer of the shielding layer;
wherein the shielding layer comprises a first joint portion, a second joint portion and an overlapping area; the overlapping area is formed by superimposing the first joint portion of the shielding layer and the second joint portion of the shielding layer; the first metal layer of the first joint portion and the second metal layer of the second joint portion are in contact with each other at the overlapping area;
wherein the shielding layer comprises a first arc-shaped portion, a second arc-shaped portion opposite to the first arc-shaped portion, a first straight portion connecting one side of the first arc-shaped portion and one side of the second arc-shaped portion, and a connecting area opposite to the first straight portion; the connecting area comprises the overlapping area and a second straight portion; the first joint portion is connected to the first arc-shaped portion; the second straight portion is connected to the second arc portion;
wherein the connecting area further comprises a raised portion; opposite sides of the raised portion are connected to the second joint portion and the second straight portion, respectively; and the raised portion gradually moves away from the second straight portion toward the second joint portion; the cable is not provided with any ground wire, and at least part of the first metal layer of the second joint portion serves as a grounding element of the cable;
wherein the first metal layer of the first joint portion and the second metal layer of the second joint portion are in direct contact with each other at the overlapping area; the second metal layer of the first joint portion is integrally composited to an inner side of the first metal layer of the first joint portion; and the first metal layer of the second joint portion is integrally composited to an outer side of the second metal layer of the second joint portion; and
wherein the first metal conductor, the first insulator, the second metal conductor, the second insulator, the intermediate layer material, the shielding layer and the insulating layer are exposed outside the insulating skin.
